(19) United States
(12) Patent Application Publication
(10) Pub. No.: US 2026/0305622 A1
(43) Pub. Date: Oct. 8, 2026

(54) PEEL WITH CONVEYOR ASSEMBLY

(71) Applicant: Jean DESPRES, St-Antonin (CA)

(72) Inventor: Jean DESPRES, St-Antonin (CA)

(21) Appl. No.: 19/460,580

(22) Filed: Jan. 27, 2026

Related U.S. Application Data
(60) Provisional application No. 63/750,321, filed on Jan. 28, 2025.

(51) Int. Cl. A21B 3/00; A47J 43/28

(52) U.S. Cl. CPC A21B 3/003; A47J 43/283

(57) ABSTRACT

A peel for manipulating baked goods such as pizza, comprising a handle. A support panel at or near a leading end of the handle. A pair of elongated rollers is rotatably supported by the support panel, with one of the elongated rollers being at a leading end of the support panel, and another one of the elongated rollers being at a trailing end of the support panel. A belt is rotatably supported by and between the elongated rollers. A method for placing an item to be cooked on a surface from a peel having a belt is also provided.

### CROSS-REFERENCE TO RELATED APPLICATION

The application claims priority of U.S. Patent Application No. 63/750,321, filed on Jan. 28, 2025 and incorporated herein by reference.

### TECHNICAL FIELD

The application relates a tool for manipulating a pizza or like flat bread, crust, etc.

### BACKGROUND

Pizza is a popular dish around the world. It is commonly prepared as a piece of flattened fresh dough, uncooked, upon which toppings are laid. The toppings can vary according to one's taste, but typically include a sauce such as tomato sauce, a cheese, and vegetables, meats, spices, as examples.

One challenge is the manipulation of the pizza into and out of the oven. Because in many instances the pizza lies on its flattened fresh dough, it may not have structural integrity. Therefore, pizza peels have been developed to manipulate the pizza, the pizza peels also known as pizza spatula, pizza tool. The pizza peels feature a thin flat panel, referred to as a carrying surface, as a paddle, as a head, from which projects a handle.

Because of its thinness, the flat panel of the pizza peel may be slid under the uncooked pizza for the uncooked pizza to lay in the main plane of the flat panel. The pizza peel may then be carried via the handle into an oven. In the oven, some dexterity may be required to leave the uncooked pizza on a cooking surface of the oven. The pizza peel may then be used to remove the cooked pizza, though with greater ease as the cooked dough will have gained some rigidity.

In spite of the availability of pizza peels, it may nevertheless be a challenge to manipulate pizza, especially for the occasional user. Some models of pizza peels have been developed to feature a conveyor mat, but the construction may not be optimal for ease of use.

### SUMMARY

In one aspect, there is provided a peel comprising a handle; a support panel at a leading end of the handle; a pair of elongated rollers rotatably supported by the support panel, with one of the elongated rollers being at a leading end of the support panel, and another one of the elongated rollers being at or near a trailing end of the support panel; and a belt rotatably supported by and between the elongated rollers.

Further in accordance with the aspect, for instance, free ends of the belt are pressed against one another by bars.

Still further in accordance with the aspect, for instance, the bars are releasably fastened to one another.

Still further in accordance with the aspect, for instance, the elongated roller at the leading end of the support panel is supported by a pair of fingers projecting forwardly from a remainder of the support panel.

Still further in accordance with the aspect, for instance, the pair of fingers project upwardly and forward from the remainder of the support panel.

Still further in accordance with the aspect, for instance, plain bearings are defined between the pair of fingers and the elongated roller at the leading end of the support panel.

Still further in accordance with the aspect, for instance, the elongated roller at or near the trailing end of the support panel is supported at opposite ends by a pair of mounts of a slot in the support panel.

Still further in accordance with the aspect, for instance, plain

bearings are defined between the pair of mounts and the elongated roller at the leading end of the support panel.

Still further in accordance with the aspect, for instance, the slot defines a pair of enlargements at ends to accommodate the mounts.

Still further in accordance with the aspect, for instance, a tab may be on a top surface of the belt to manipulate the belt relative to the support panel.

In accordance with another aspect, there is provided a method for placing an item to be cooked on a surface from a peel having a belt, the method comprising: with a first hand of a user, supporting the peel with the item to be cooked on the belt; placing a second hand of the user on a manipulable portion of the belt; and with the second hand, causing the belt to cycle on a pair of rollers by moving the manipulable portion of the belt for the item to be cooked to move in a leading direction of the peel, off of the belt and onto the surface.

Further in accordance with the other aspect, for instance, placing an item to be cooked on a surface from a peel includes placing a pizza onto a surface of an over.

Still further in accordance with the other aspect, for instance, placing a second hand of the user on a manipulable portion of the belt includes placing the second hand on a tab projecting upwardly from a surface of the belt.

Still further in accordance with the other aspect, for instance, placing the second hand on the tab includes placing fingers of the second hand on the tab.

Still further in accordance with the other aspect, for instance, moving the manipulable portion of the belt includes pushing the manipulable portion of the belt toward the leading direction.

### DESCRIPTION OF THE DRAWINGS

Reference is now made to the accompanying figures in which:

FIG. 1 is a perspective view of a pizza peel in accordance with the present disclosure;

FIG. 2 is a perspective view of the pizza peel of FIG. 1, with a conveyor belt removed;

FIG. 3 is an enlarged perspective view of a trailing roller of the pizza peel of FIG. 1;

FIG. 4 is a sectional view showing a part of the conveyor assembly of the pizza peel of FIG. 1; and

FIG. 5 is an enlarged perspective view of a leading roller of the pizza peel of FIG. 1.

### DETAILED DESCRIPTION

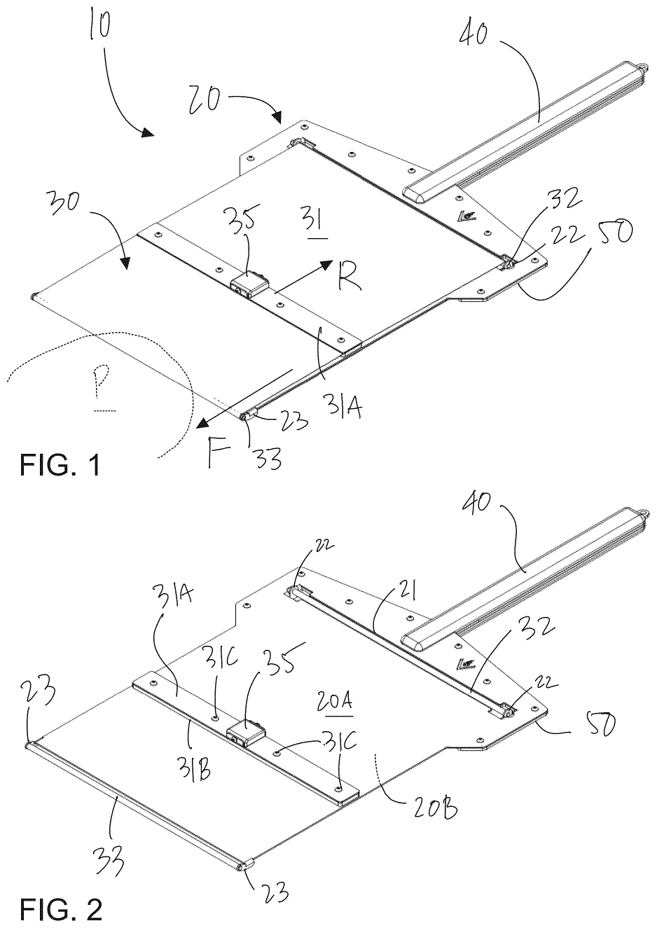

Referring to the drawings and more particularly to FIGS. 1 and 2, a peel in accordance with the present disclosure is generally shown at 10, relative to a pizza P, hence a pizza peel 10. While the expression «pizza peel» is used, other expressions could be used to describe the tool 10, such as pizza spatula, pizza tool, etc. Moreover, while the pizza peel could be used to manipulate pizza, it could be used to manipulate other baked goods and items to be cooked, such as bread loaves, flat bread, cakes, pastries, etc. The present disclosure is not limited to a tool for manipulating pizza even though, for simplicity, reference is made to manipulation of a pizza.

The pizza peel 10 may have a support panel 20, a conveyor assembly 30, a handle 40 and/or a backing panel 50. The support panel 20 is the structural component of the pizza peel 10 upon which the pizza will be laid. The conveyor assembly 30 is the moving component that is mounted onto the support panel 20 and will be used to facilitate the disposing of and picking up of the pizza. The handle 40 allows the user to move the pizza peel 10 around, and allows a user to deposit or pick up the pizza into/from the oven, while positioned at a standpoint exterior to the oven.

Referring to FIGS. 1 and 2, the support panel 20 has an enlarged shape in contrast to the handle 40. It may be made of a flat panel of a metal, or other materials that can sustain oven temperatures, including wood. For example, the support panel 20 is made of aluminum, but other metals could be used. The support panel 20 may be substantially flat, with a top surface 20A and an undersurface 20B. The support panel 20 may have different shapes, notably as a function of the baked goods the peel 10 will be used with. For example, if the peel 10 is a pizza peel, the support panel 20 may be generally square, with optional rounded corners, for pizzas that are typically round. Other shapes include rectangular, round, oval, polygonal, etc. In the illustrated embodiment, the leading portion of the support panel 20 is rectangular, and the trailing end of the support panel 20 is enlarged.

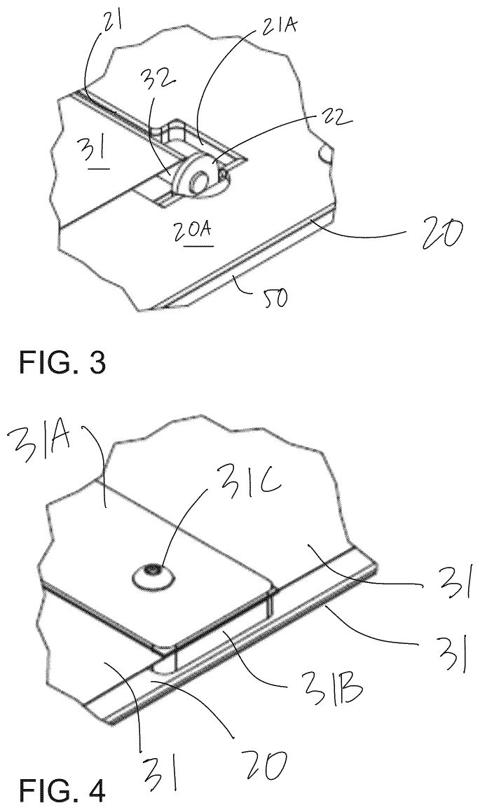

A slot 21 is defined through the support panel 20, i.e., from top surface 20A to the undersurface 20B, the slot 21 being at a trailing end of the peel 10. The slot 21 will receive a roller of the conveyor assembly 30 as described below. The slot 21 may be on a trailing side of the support panel 20, i.e., the side that trails when the peel 10 is inserted into the oven. Referring to FIGS. 1, 2 and 3, mounts 22 are at the ends of the slot 21, with the slots 21 optionally defining enlargements such as 21A to accommodate the mounts 22. The mounts 22 may be bent from the material of the support panel 20. Alternatively, the mounts 22 may be added, such as in the form of blocks, etc. The mounts 22 each define a hole, with the mounts 22 serving as plain bearings, or bearing supports. The slot 21 is an option, as it is possible for a trailing roller to be supported by a pair of fingers in a similar manner as the roller at the leading end of the peel 10, described below.

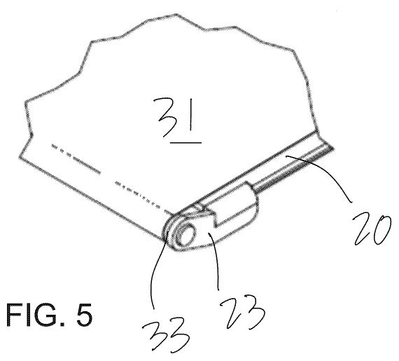

Referring to FIGS. 1, 2 and 5, fingers 23 may project from a leading end of the support panel 20. The fingers 23 may also receive a roller of the conveyor assembly 30 as described below. The fingers 23 may be bent from the material of the support panel 20. Alternatively, the fingers 23 may be added, such as in the form of blocks, clips, etc. The fingers 23 each define a hole, with the fingers 23 serving as plain bearings, or bearing supports. In a variant, the free ends of the fingers 23 may tilt upwardly, i.e., relative to a top and bottom of the support panel 20. Considering that the peel 10 may be tilted downwardly when picking up or depositing a baked good, the tilt of the free ends of the fingers 23 may assist in keeping the leading end of the conveyor assembly 30 generally horizontal, or closer to a horizontal orientation.

Referring to FIG. 1, the conveyor assembly 30 is shown having a belt 31. While the expression “belt” is used, other expressions could be used to describe this component, such as conveyor, tarp, mat, etc. The belt 31 may be a panel of a flexible material. By “flexible”, it is meant that the belt 31 is non rigid, like a fabric or cloth, and can be deformed. However, the belt 31 may have limited in-plane stretchability, i.e., it has limited stretch when pulled at opposed ends. The belt 31 may be made of a fabric (e.g., woven or non-woven), a polymer (e.g., silicone rubber, Teflon®), selected to sustain temperatures of an oven. It may have a coating etc to be protected from eat. The material may be selected to be food grade, considering that the belt 31 will contact the baked good manipulated by the peel 10.

Referring to FIGS. 1 and 4, bars 31A and 31B may be used to close the free ends of the belt 31 onto themselves, and hence define an endless configuration. The bars 31A and 31B may be strips of a rigid material, such as a metal, with fasteners 31C tightening the bars 31A and 31B against one another. Holes may thus be present in the free ends of the belt 31 for the fasteners 31C to pass through it. Therefore, it may be said that the free ends of the belt 31 are sandwiched on one another. The assembly of bars 31A and 31B is optional, but can advantageously allow a user to remove the belt 31, such as if one wants to clean up or replace the belt 31. Alternatively, the belt 31 could be permanently mounted onto the support panel 20, such as by stitching, adhesives, etc.

Referring to FIGS. 1-3, rear roller 32 is rotatably supported by the mounts 22 and is in the slot 21, such that the rear roller 32 may roll about its own axis, like an idler. In a variant, the rear roller 32 is an elongated rod, i.e., a single rod, that may have a constant diameter. Ends of the rear roller 32 may have a smaller diameter to be received into the hole of the mounts 22, such that the assembly forms a plain bearing. It is also considered to add a rivet, a bolt or the like at the ends, as an alternative. Bearings other than plain bearings could also be used.

Referring to FIGS. 1, 2 and 5, front roller 33 is rotatably supported by the fingers 23 and defines a leading end of the peel 10. The front roller 33 may roll about its own axis, like an idler. In a variant, the front roller 33 is an elongated rod, that may have a constant diameter. Ends of the front roller 33 may have a smaller diameter to be received into the hole of the fingers 23, such that the assembly forms a plain bearing. It is also considered to add a rivet, a bolt or the like at the ends, as an alternative. Bearings other than plain bearings could also be used.

As an alternative to rollers 32 and 33, it is possible to provide a rounded edge surface at a leading edge of the support panel 20, and another rounded edge surface in the slot 21. The belt 31 would slide against such rounded edge surfaces. The rounded edge surfaces would have a radius of at least 1/16″

Thus, the belt 31 is tautened between the rear roller 32 and the front roller 33. The belt 31 may therefore move in a cyclic manner relative to the support panel 20, i.e., the belt 31 cycles. A tab 35 may project upwardly from the bar 31A. The tab 35 is one type of manipulable portion by which the belt 31 may be displaced. The tab 35 may be screwed, bolted onto the bar 31A, or may be an integral part of it. As observed, it may be centrally located relative to the bar 31A, to be ergonomically positioned for a user to access it. The user may therefore grasp the tab 35, and then exert a pull or push on the tab, to pick up or deposit a baked good onto or from the belt 31. The tab 35 is optional, or could take other forms. For example, the user could manipulate the belt 31 directly, or could use the bar 31A if present. As an alternative to the tab 35, the manipulable portion may be a crank operatively connected to one of the rollers, or part of the tarp of the belt 31 (i.e., no need for a tab). The tab 35 could be on an underside of the peel 10 as an alternative.

Referring to FIGS. 1 and 2, the handle 40 projects from a rear end of the support panel 20. The handle 40 may have any shape, and it typically an elongated stick or rod, that may be hollow, solid, etc. An eyelet could be present at the rear end of the handle 40. Gripping material could be provided on a surface of the handle 40. The handle 40 could be made of a plastic, of wood, of metal, or any combination thereof. Because a user's hand may be required to manipulate the tab 35, as described below, it may be required for the handle 40 to have a given length, such that the user may hold the handle 40 with a single hand while having the option of abutting he handle 40 against her/his forearm by way of the length. In a variant, the handle 40 has a minimum length of 5 inches, but the handle 40 may also have a minimum length of at least 9 inches. The handle 40 could be connected to sides of the support panel 20 as an alternative.

A backing panel 50 may be present at the rear end of the support panel 20, and at a junction with the handle 40. The backing panel 50 may be present to add stiffness to this portion of the support panel 20, i.e., where the support panel 20 is cantilevered relative to the handle 40. The backing panel 50 may have a U-shape, to match the enlarged portion of the support panel 20, and extend parallel to the slot 21. The backing panel 50 is one possible way, among numerous ways, to reinforce this portion of the support panel 20, with ribs being an option, a thickening of parts another option. The reinforcement may not be necessary depending on the materials selected for the support panel 20.

Now that the various components of the peel 10 have been described, a use thereof is set forth. For simplicity, the use will be explained with fresh uncooked pizza P being manipulated by the peel 10, with reference to FIG. 1.

Assuming that the item to be baked, e.g., fresh uncooked pizza, is ready to be picked up, it may be preferred that the tab 35 (or equivalent) be brought closer to the leading end of the peel 10, if not already there. This may be done by the user holding the peel 10 by the handle 40 in one hand (for example with a free end of the handle 40 abutted against the forearm), and pushing the tab 35 (or bar 31A or belt 31) toward the leading end of the peel 10 with the other hand. If the tab 35 is on an under surface, a pull could be applied instead.

The leading end of the peel 10, i.e., where the belt 31 covers the front roller 33, is positioned under the fresh uncooked dough. This may require that the user lifts the pizza at its end facing the peel 10, to slip the leading end of the peel 10 under the dough. It may be for just an inch, or like fraction of the overall size of the pizza. However, the peel 10 may also be fitted under the pizza, without having to manually raise the dough.

Once the peel 10 is under the pizza, the fresh uncooked dough has a small portion thereof on the belt 31. The user may then concurrently displace the peel 10 in a forward direction F (FIG. 1) via the handle 40, while pulling back on the tab 35 in a rearward direction R. From a global perspective, this may have the effect of the tab 35 generally maintaining its position, while the leading edge of the peel 10 moves under the pizza P. The pizza P therefore moves onto the belt 31. This step is continued until the pizza P is entirely onto the belt 31.

The peel 10 may then be used to bring the pizza P to the oven, with the pizza P and support panel 20 placed into the cavity of the oven. The user may then concurrently displace the peel 10 in the rearward direction R (FIG. 1) via the handle 40, while pushing the tab 35 in the forward direction F. From a global perspective, this may also have the effect of the tab 35 generally maintaining its position, while the leading edge of the peel 10 gradually liberates the underside of the pizza P. The pizza P therefore moves onto the cooking surface. This step is continued until the pizza P is entirely onto the cooking surface. This step may require that the tab 35 be in the oven for a few seconds. Precautions should be taken to avoid burns, such as wearing an over mitt, using a push rod to push the tab 35.

Therefore, the peel 10 may be used in a method for placing an item to be cooked on a surface, by: with a first hand of a user, supporting the peel with the item to be cooked on the belt; placing a second hand of the user on a manipulable portion of the belt; and with the second hand, causing the belt to cycle on a pair of rollers by moving the manipulable portion of the belt for the item to be cooked to move in a leading direction of the peel, off of the belt and onto the surface. Placing an item to be cooked on a surface from a peel includes placing a pizza onto a surface of an over. Placing a second hand of the user on a manipulable portion of the belt includes placing the second hand on a tab projecting upwardly from a surface of the belt. Placing the second hand on the tab includes placing fingers of the second hand on the tab. Moving the manipulable portion of the belt includes pushing the manipulable portion of the belt toward the leading direction.

The peel 10 may generally be described as having a handle; a support panel at a leading end of the handle; a pair of elongated rollers rotatably supported by the support panel, with one of the elongated rollers being at a leading end of the support panel, and another one of the elongated rollers being at a trailing end of the support panel; and a belt rotatably supported by and between the elongated rollers. Free ends of the belt are pressed against one another by bars. The bars are releasably fastened to one another. The elongated roller at the leading end of the support panel is supported by a pair of fingers projected forwardly from a remainder of the support panel. The pair of fingers project upwardly and forward from the remainder of the support panel. Plain bearings are defined between the pair of fingers and the elongated roller at the leading end of the support panel. The elongated roller at the trailing end of the support panel is supported by a pair of tabs at opposite ends of a slot in the support panel. Plain bearings are defined between the pair of tabs and the elongated roller at the leading end of the support panel. A tab may be on a top surface of the belt to manipulate the belt relative to the support panel.

The above description is meant to be exemplary only, and one skilled in the art will recognize that changes may be made to the embodiments described without departing from the scope of the invention disclosed. Still other modifications which fall within the scope of the present invention will be apparent to those skilled in the art, in light of a review of this disclosure, and such modifications are intended to fall within the appended claims.

1. A peel comprising
a handle;
a support panel at a leading end of the handle;
a pair of elongated rollers rotatably supported by the support panel, with one of the elongated rollers being at a leading end of the support panel, and another one of the elongated rollers being at or near a trailing end of the support panel; and
a belt rotatably supported by and between the elongated rollers.

2. The peel according to claim 1, wherein free ends of the belt are pressed against one another by bars.

3. The peel according to claim 2, wherein the bars are releasably fastened to one another.

4. The peel according to claim 1, wherein the elongated roller at the leading end of the support panel is supported by a pair of fingers projecting forwardly from a remainder of the support panel.

5. The peel according to claim 4, wherein the pair of fingers project upwardly and forward from the remainder of the support panel.

6. The peel according to claim 4, wherein plain bearings are defined between the pair of fingers and the elongated roller at the leading end of the support panel.

7. The peel according to claim 1, wherein the elongated roller at or near the trailing end of the support panel is supported at opposite ends by a pair of mounts of a slot in the support panel.

8. The peel according to claim 7, wherein plain bearings are defined between the pair of mounts and the elongated roller at the leading end of the support panel.

9. The peel according to claim 7, wherein the slot defines a pair of enlargements at ends to accommodate the mounts.

10. The peel according to claim 1, further including a tab on a top surface of the belt to manipulate the belt relative to the support panel.

11. A method for placing an item to be cooked on a surface from a peel having a belt, the method comprising:
with a first hand of a user, supporting the peel with the item to be cooked on the belt;
placing a second hand of the user on a manipulable portion of the belt; and
with the second hand, causing the belt to cycle on a pair of rollers by moving the manipulable portion of the belt for the item to be cooked to move in a leading direction of the peel, off of the belt and onto the surface.

12. The method according to claim 11, wherein placing an item to be cooked on a surface from a peel includes placing a pizza onto a surface of an over.

13. The method according to claim 11, wherein placing a second hand of the user on a manipulable portion of the belt includes placing the second hand on a tab projecting upwardly from a surface of the belt.

14. The method according to claim 11, wherein placing the second hand on the tab includes placing fingers of the second hand on the tab.

15. The method according to claim 11, wherein moving the manipulable portion of the belt includes pushing the manipulable portion of the belt toward the leading direction.
